(19) United States
(12) Patent Application Publication
(10) Pub. No.: US 2017/0367073 A1
(43) Pub. Date: Dec. 21, 2017

(54) UE CAPABILITY EXCHANGE FOR CARRIER AGGREGATION

(71) Applicant: QUALCOMM Incorporated, San Diego, CA (US)

(72) Inventors: Muralidharan MURUGAN, San Diego, CA (US); Nitin PANT, San Diego, CA (US); Muthukumaran DHANAPAL, Sunnyvale, CA (US)

(21) Appl. No.: 15/601,152

(22) Filed: May 22, 2017

Related U.S. Application Data
(60) Provisional application No. 62/350,597, filed on Jun. 15, 2016.

(51) Int. Cl. H04W 72/02; H04L 5/00; H04W 72/04; H04B 1/00; H04L 12/64

(52) U.S. Cl. CPC H04W 72/02; H04W 72/042; H04W 72/0413; H04B 1/0053; H04L 5/0092; H04L 2012/6486

(57) ABSTRACT

A method, apparatus, and computer-readable medium that reduce UE capability message sizes are disclosed. The apparatus receives a request for UE capability information, wherein the request indicates at least one network supported UE capability. The UE sends a targeted response indicating a capability specific to the network supported UE capability and refrains from indicating other capabilities of the UE that are not indicated by the network in the request. The request may comprise a plurality of supported CA band combinations and a network-specific set of features supported in connection with the plurality of CA band combinations. The response may comprise, for each CA band combination in the plurality of requested CA band combinations, an indication of whether the CA band combination is supported by the UE and a separate indication of support or a lack of support for each feature in the set of network-specific features when operating in the CA band combination.

### CROSS-REFERENCE TO RELATED APPLICATION

This application claims the benefit of U.S. Provisional Application Ser. No. 62/350,597, entitled “UE Capability Exchange For Carrier Aggregation” and filed on Jun. 15, 2016, which is expressly incorporated by reference herein in its entirety.

### BACKGROUND

### Field

The present disclosure relates generally to communication systems, and more particularly, to a UE capability exchange for network supported capabilities.

### Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to support mobile broadband access through improved spectral efficiency, lowered costs, and improved services using OFDMA on the downlink, SC-FDMA on the uplink, and multiple-input multiple-output (MIMO) antenna technology. In another example, a fifth generation (5G) wireless communications technology (which can be referred to as new radio (NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

However, as the demand for mobile broadband access continues to increase, there exists a need for further improvements in wireless communication technology. These improvements may also be applicable to other multi-access technologies and the telecommunication standards that employ these technologies.

In a UE capability exchange, a network sends a request to a UE that responds with its capabilities. As the amount of possible user equipment (UE) capabilities increases, so does the size of a capability response from a UE. In one example, a UE is required to indicate all of the carrier aggregation (CA) band combinations that the UE supports. As the number of possible CA band combinations increases, the size of the capability message from the UE becomes very large. Some networks may be unable to handle such large capability messages. Even networks able to handle the large sized capability messages may benefit from a more efficient use of wireless communication resources.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The size of a capability response from a UE increases based on the number of possible UE capabilities that the UE supports. In one example, a UE is required to indicate all of the CA band combinations that the UE supports. As the amount of possible CA band combinations increases, the size of the capability message from the UE may become very large.

Although a large number of CA band combinations may be supported by a UE, a network may deploy only a few sets of CA band combinations as compared to the number of different CA band combinations supported by the UE.

Aspects presented herein provide a way to reduce the amount of signaling for UE capability reporting by having a network request a response from the UE for network-specific capabilities that the UE supports. The present disclosure enables a network to request information pertaining to a subset of a UE's capabilities which may be of particular interest to the requesting network. The requested capabilities may differ from place to place. The UE may receive this request and send a capability response for the indicated network-specific capabilities.

Some networks may be unable to handle the large capability messages that are required for a UE to report all of the UE's capabilities to the network. Even networks able to handle the large sized capability messages would benefit from a more efficient use of wireless communication resources. Similarly, the UE benefits by reducing the requirement to construct and send large uplink (UL) messages to indicate the UE's capabilities.

In an aspect of the disclosure, a method, a computer-readable medium, and an apparatus are provided. The apparatus receives a request for UE capability information, wherein the request indicates at least one network supported UE capability and transmits a response indicating capability for the indicated at least one network supported UE capability. The request may include a plurality of CA band combinations and a network-specific set of supported features corresponding to the plurality of CA band combinations. The response to the request may include, for each CA band combination in the plurality of CA band combinations, an indication of whether the CA band combination is supported and a separate indication of support or a lack of support for each feature in the set of network-specific features when operating in the CA band combination.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating LTE examples of a DL frame structure, DL channels within the DL frame structure, an UL frame structure, and UL channels within the UL frame structure, respectively.

FIG. 3 is a diagram illustrating an example of an evolved Node B (eNB) and user equipment (UE) in an access network.

FIGS. 4A and 4B illustrates examples of carrier aggregation.

FIG. 5 illustrates an example UE capability exchange.

FIG. 6 illustrates an example UE capability exchange including an indication of CA combinations from the network.

FIGS. 7A and 7B illustrate example aspects of UE capability exchange messages.

FIGS. 8A and 8B illustrate example bitstrings corresponding to network supported sets of features.

FIG. 9 is a flowchart of a method of wireless communication.

FIG. 10 is a conceptual data flow diagram illustrating the data flow between different means/components in an exemplary apparatus.

FIG. 11 is a diagram illustrating an example of a hardware implementation for an apparatus employing a processing system.

FIG. 12 is a flowchart of a method of wireless communication.

FIG. 13 is a conceptual data flow diagram illustrating the data flow between different means/components in an exemplary apparatus.

FIG. 14 is a diagram illustrating an example of a hardware implementation for an apparatus employing a processing system.

FIG. 15 is a flowchart of a method of wireless communication.

FIG. 16 is a flowchart of a method of wireless communication.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

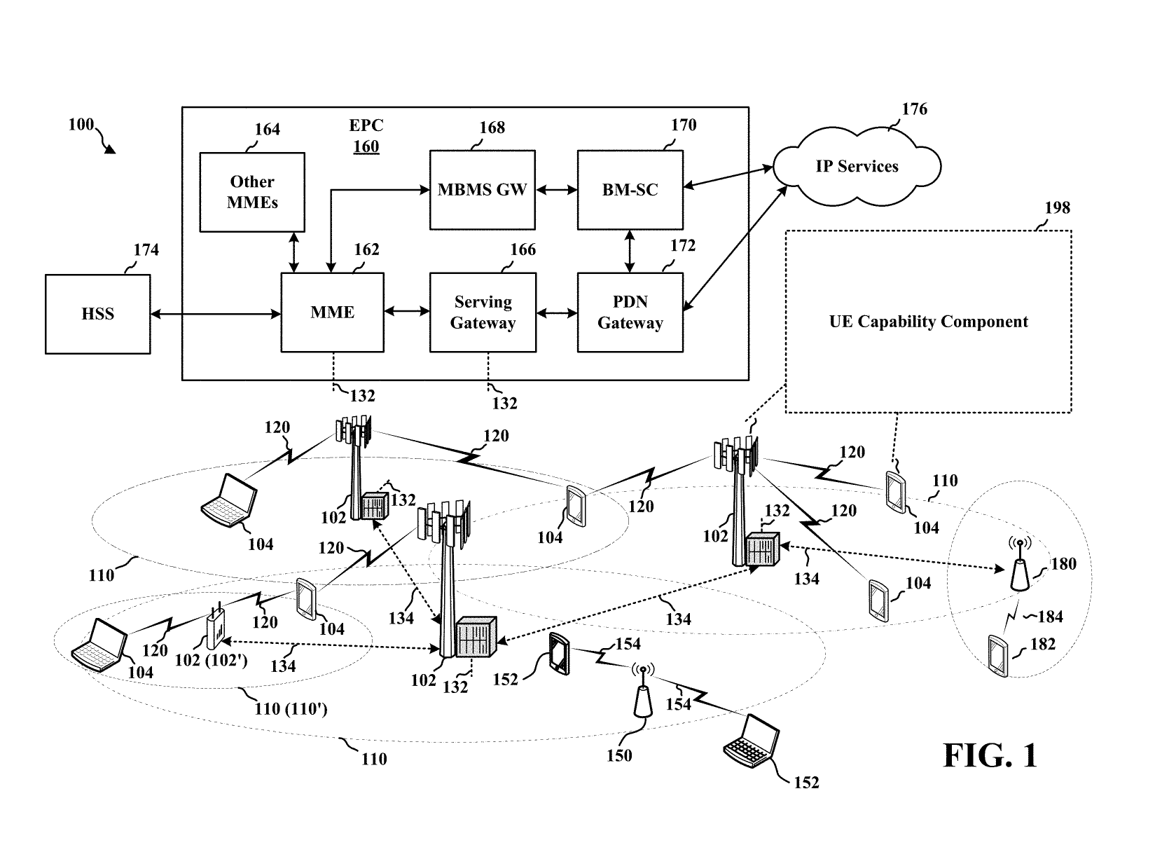

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include eNBs (LTE) or gNBs (NR). The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The geographic coverage area 110 for a base station 102 may be divided into sectors or cells making up only a portion of the coverage area (not shown). The wireless communication network 100 may include base stations 102 of different types (e.g., macro base stations or small cell base stations, described above). Additionally, the plurality of base stations 102 may operate according to different ones of a plurality of communication technologies (e.g., 5G (New Radio or “NR”), fourth generation (4G)/LTE, 3G, Wi-Fi, Bluetooth, etc.), and thus there may be overlapping geographic coverage areas 110 for different communication technologies. The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links may be through one or more carriers. The base stations 102/UEs 104 may use spectrum up to Y MHz (e.g., 5, 10, 15, 20 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ LTE and use the same 5 GHz unlicensed frequency spectrum as used by the Wi-Fi AP 150. The small cell 102′, employing LTE in an unlicensed frequency spectrum, may boost coverage to and/or increase capacity of the access network. LTE in an unlicensed spectrum may be referred to as LTE-unlicensed (LTE-U), licensed assisted access (LAA), or MuLTEfire.

The millimeter wave (mmW) base station 180 may operate in mmW frequencies and/or near mmW frequencies in communication with the UE 182. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 182 to compensate for the extremely high path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a Node B, evolved Node B (eNB), a next generation Node B (gNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, or any other similar functioning device. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 and/or the base station 102, 180 may be configured to include a UE capability component (198) that enables the base station 102 and the UE 104 to perform an improved UE capability exchange. This capability exchange may involve any network feature for which the UE can signal capability support. In one example, the capability exchange may comprise UE capabilities for carrier aggregation. For the base station, the UE capability component may operate to control UE capability enquiries to include information regarding the CA band combinations supported by the network and corresponding features that the base station deploys in order to receive a UE capability response that is tailored to the resources deployed by the network. For the UE, the UE capability component may operate to receive such a UE capability enquiry and to respond to the base station by transmitting a UE capability response for the CA combinations and/or features indicated by the network.

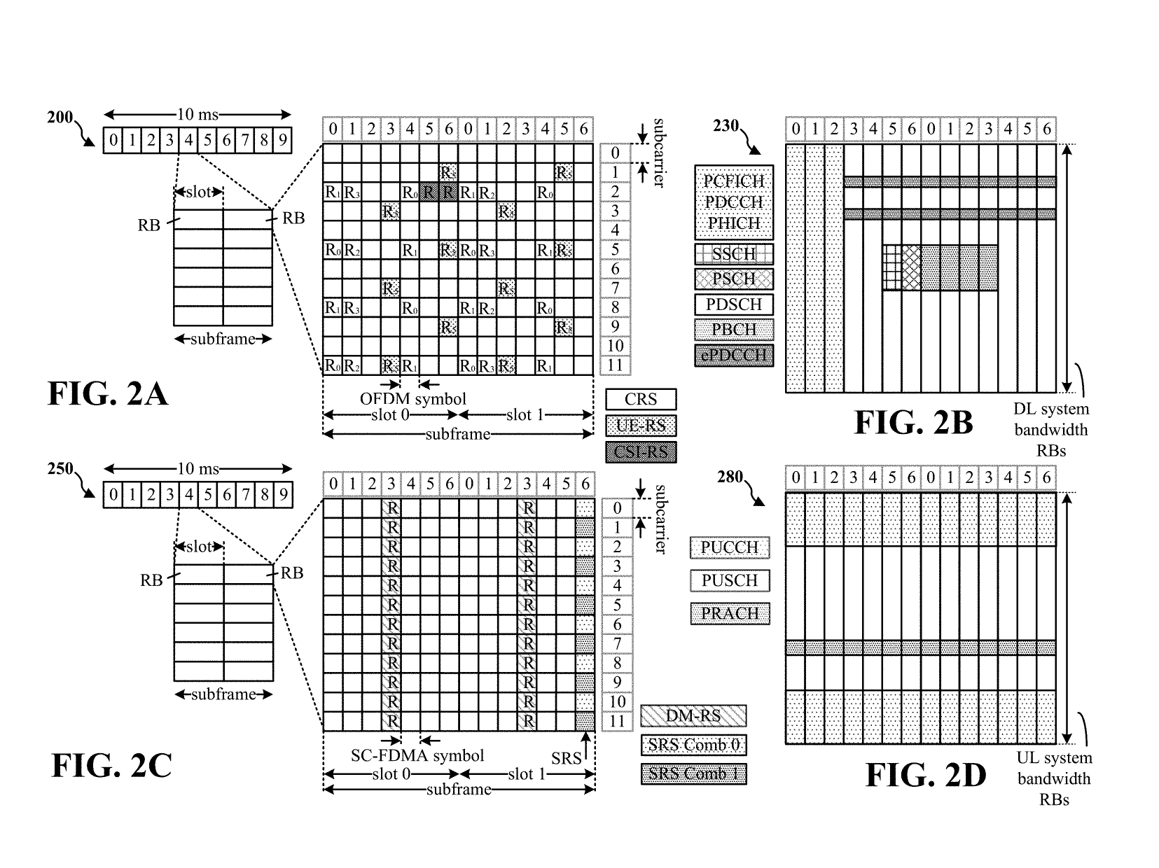

FIG. 2A is a diagram 200 illustrating an example of a DL frame structure in LTE. FIG. 2B is a diagram 230 illustrating an example of channels within the DL frame structure in LTE. FIG. 2C is a diagram 250 illustrating an example of an UL frame structure in LTE. FIG. 2D is a diagram 280 illustrating an example of channels within the UL frame structure in LTE. Other wireless communication technologies may have a different frame structure and/or different channels. In LTE, a frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). In LTE, for a normal cyclic prefix, an RB contains 12 consecutive subcarriers in the frequency domain and 7 consecutive symbols (for DL, OFDM symbols; for UL, SC-FDMA symbols) in the time domain, for a total of 84 REs. For an extended cyclic prefix, an RB contains 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 2A illustrates CRS for antenna ports 0, 1, 2, and 3 (indicated as R₀, R₁, R₂, and R₃, respectively), UE-RS for antenna port 5 (indicated as R₅), and CSI-RS for antenna port 15 (indicated as R). FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (NACK) feedback based on the physical uplink shared channel (PUSCH). The primary synchronization channel (PSCH) is within symbol 6 of slot 0 within subframes 0 and 5 of a frame, and carries a primary synchronization signal (PSS) that is used by a UE to determine subframe timing and a physical layer identity. The secondary synchronization channel (SSCH) is within symbol 5 of slot 0 within subframes 0 and 5 of a frame, and carries a secondary synchronization signal (SSS) that is used by a UE to determine a physical layer cell identity group number. Based on the physical layer identity and the physical layer cell identity group number, the UE can determine a physical cell identifier (PCI). Based on the PCI, the UE can determine the locations of the aforementioned DL-RS. The physical broadcast channel (PBCH) is within symbols 0, 1, 2, 3 of slot 1 of subframe 0 of a frame, and carries a master information block (MIB). The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the eNB. The UE may additionally transmit sounding reference signals (SRS) in the last symbol of a subframe. The SRS may have a comb structure, and a UE may transmit SRS on one of the combs. The SRS may be used by an eNB for channel quality estimation to enable frequency-dependent scheduling on the UL. FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

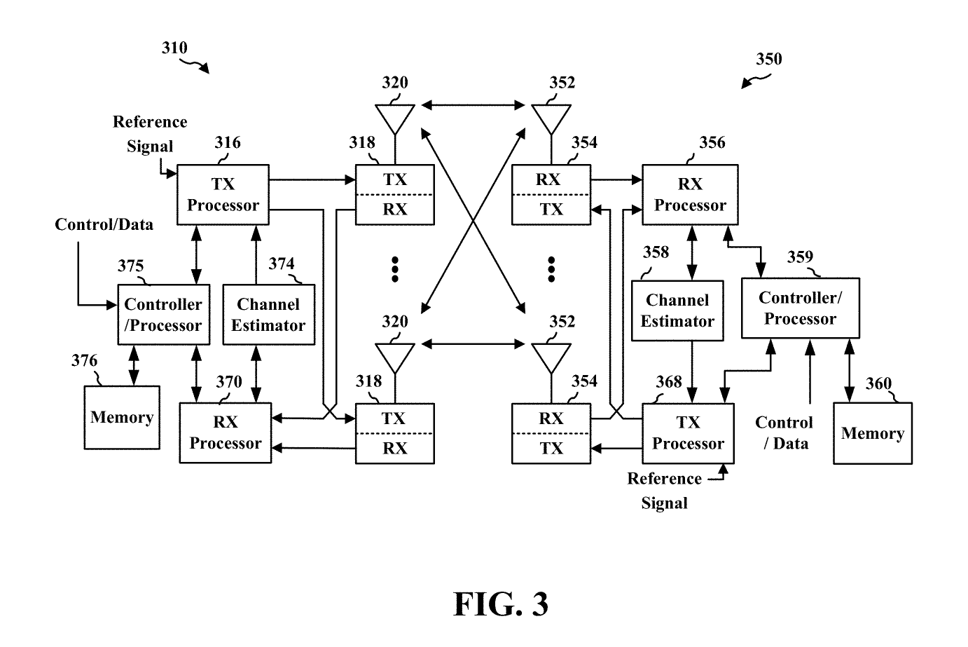

FIG. 3 is a block diagram of an base station 310 in communication with a UE 350 in an access network. base station 310 and UE 350 may operate as described in connection with FIG. 1 and may communicate according to a set of capabilities which is determined through a capabilities exchange. In the DL, IP packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demuliplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demuliplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

### Carrier Aggregation

A wireless communication system may support operation on multiple cells or carriers, a feature which may be referred to as carrier aggregation (CA) or multi-carrier operation. Each aggregated carrier may be referred to as a component carrier (CC), a layer, a channel, etc. The wireless communication system may support operation over a non-contention, licensed radio frequency spectrum band and/or a contention-based shared radio frequency spectrum band.

In LTE systems, one carrier may be designated, or configured, as a Primary Component Carrier (PCC). One additional CC may be configured as a primary secondary CC (pScell). The Pcell and the pScell may carry PUCCH signals, and the Pcell may carry common search space signals. Thus, a UE will monitor common search space only on the Pcell. The other aggregated CCs are secondary CCs.

A UE may be configured with multiple CCs for CA, e.g., up to 32 CCs. Each CC may be up to 20 MHz and may be backward compatible. For example, for a UE that can be configured with up to 32 CCs, the UE may be configured for up to 640 MHz. In CA, the CCs may be FDD, TDD, or a combination of FDD and TDD. Different TDD CCs may have different the same DL/UL configuration or may have different DL/UL configurations. Special subframes may also be configured differently for different TDD CCs.

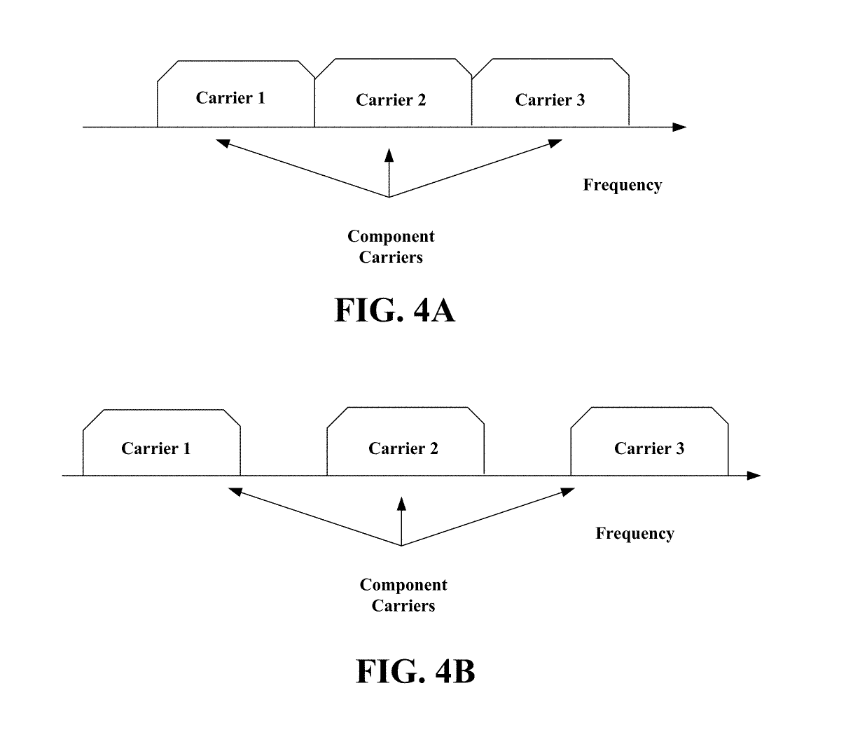

For the LTE-Advanced mobile systems, two types of carrier aggregation (CA) methods have been proposed, continuous CA and non-continuous CA. They are illustrated in FIGS. 4A and 4B. Non-continuous CA occurs when multiple available component carriers are separated along the frequency band (FIG. 4B). On the other hand, continuous CA occurs when multiple available component carriers are adjacent to each other (FIG. 4A). Both non-continuous and continuous CA aggregate multiple LTE/component carriers to serve a single unit of LTE Advanced UE.

Different UEs may support different band combinations in carrier aggregation and may have different CA capabilities with respect to their UL and DL operation.

### UE Capability Exchange

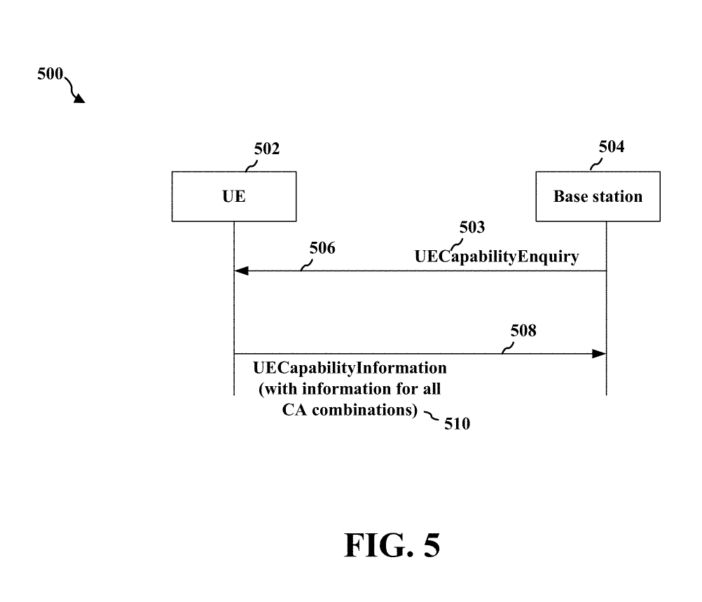

A UE capability exchange, also referred to as a UE capability transfer, may include the transfer of UE radio access capability information from a UE to the network, e.g., to an E-UTRAN. The base station and the Core Network may need to know the UE's capabilities in order to more effectively use the radio capabilities of the UE and the network with respect to different features, e.g., supported CA band combinations, DL/UL BW class, MIMO capability, TM3-4 MIMO capability, Dual Connectivity support, simultaneous RxTx, supported CSI-RS processes, etc. The base station may use the UE capability information during configurations of data radio bearer (DRB), MAC, PHY, etc. FIG. 5 illustrates an example UE Capability exchange 500. The base station 504 sends a UECapabilityEnquiry 503 to UE 502 at 506, requesting the UE to respond with UE radio access capability information. The UE 502 responds with a UECapabilityInformation message 510. The base station 504 may use the information 510 received at 508 to set up the MAC and PHY configuration (receive and transmit capabilities, e.g., single/dual radio, dual receiver) of the RRC connection. This exchange may also enable efficient measurement control.

As the number of possible UE capabilities increases, the UE capability information message may become large.

For example, UE capability information message sizes have increased many fold just due to Carrier Aggregation (CA). With carrier aggregation, multiple combinations of carriers, referred to herein as “CA band combinations” may be supported. The UE includes the UE's capabilities for each of these CA band combinations in the UE Capability exchange 500. When the UE has to explicitly indicate the supported CA band combinations to the network, along with UL/DL parameters and the number of MIMO layers, a large number of CA band combinations may result in a large UECapabilityInformation message 510 in order to include information for all supported CA band combinations.

Some networks might not be able to handle such large UE Capability information messages, e.g., with a size greater than 2K bytes. UMTS and LTE networks, for example, that request EUTRAN capabilities may have a size restriction for such messages and may not be able to handle large UE capability messages. There is therefore a need to limit the UE capability information message size.

The number of possible CA band combinations is increasing. For example, 3DL/4DL/5DL/XDL CA may be used, wherein 3DL means a 3 downlink carrier aggregation configuration, 4DL means a 4 downlink carrier aggregation configuration, 5DL means a 5 downlink carrier aggregation configuration, and XDL indicates that the number of aggregated carrier may increase up to a configuration with X downlink carrier aggregation. Additionally, there may be a CA configuration for UL, e.g., with X UL indicating a configuration with X uplink carrier aggregation. With the support of 3DL/4DL/5DL/XDL and/or X UL CA, MIMO, Dual Connectivity, etc. the potential for increase of UE capability message size is dramatic.

While a UE may receive an indication of network band(s) for UE capability exchange of CA capabilities, the UE may be required to report all of the CA combinations that the UE supports for the indicated network band(s), even though the network may actually only deploy a small set of CA band combinations.

The aspects presented in this application address the above problems and enable a UE to more efficiently use the wireless communication resources by reporting UE capabilities relevant to the capabilities supported by the network. Rather than the UE being required to “push” all of its capabilities in relation to a predetermined set of features to the network, the present disclosure provides a mechanism for the network to “pull” specified information from the UE. In response to a capabilities enquiry, the UE may omit capabilities information that is not specific to the requesting network and provide information directly responsive to the requested, network-specific capabilities. In this way, a network can target relevant UE capabilities and related features thereby utilizing its airlink resources more efficiently and avoiding problems associated with message sizes, etc.

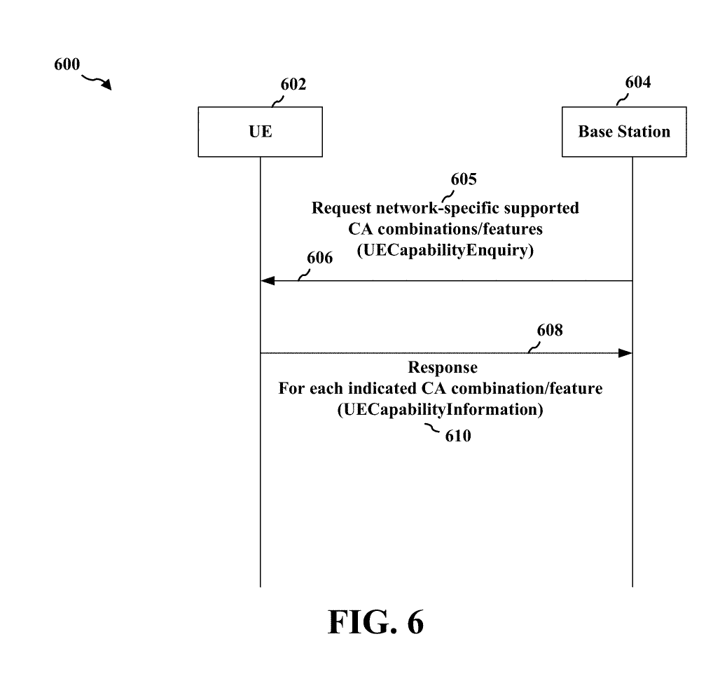

FIG. 6 illustrates an example UE capability exchange 600 in accordance with the aspects presented herein. UE 602 may correspond to, e.g., UE 104, 182, 350, 1050, apparatus 1302, 1302′. The base station 604 may correspond to e.g., base stations 102, 180, 310, 1350, and apparatus 1002, 1002′. At 606, the base station 604transmits a request 605, such as a capability enquiry message, including at least some capabilities determined or selected by the network. These network-specific capabilities may reflect features supported by (or implemented in) a particular network. The request may indicate, e.g., the CA band combinations and/or network-specific sets of features in relation to which the network wants a response from the UE. This allows the network to pull, e.g., prompt, UE capability information relevant to a particular network deployment of a wireless network operator and thus the capabilities request may vary from location to location and across networks. For the CA band combination example, the base station may request UE capabilities for specific CA band combination resources and network-specific features for those CA band combinations. For example, the UE capability request 605 may include an indication of all of the CA combinations that are deployed by the wireless network operator and a set of network-specific features corresponding to those CA band combinations. This request 605 triggers the UE 602 to respond at 608 and send the UE's capabilities related to only those CA combinations and/or set of features deployed by the wireless network operator in message 610 to base station 604.

Thus, the base station 604 may include information in a UE Capability Enquiry message 605 that will prompt the UE 602 to respond 608 with capability information for the capabilities supported by the network and to omit information about UE capabilities which fall outside the scope of the request.

For example, the network may want to know about the UE capability for the relevant CA band combinations and corresponding features that the network supports rather than all UE CA band combination capabilities. Each wireless network carrier may own or deploy a few sets of bands, and therefore only deploys a few CA band combinations using the deployed bands, as compared to all the different CA band combinations on the network requested bands that a UE may support. Only UE capability information involving the bands and CA band combinations that are deployed by the carrier network may be relevant to the network operator. Any additional UE capability information regarding CA band combinations not deployed by the network operator may provide little additional benefit to the network. Instead, the additional information may consume valuable wireless communication resources.

Therefore, rather than having UE 602 inform the network of all supported CA band combinations, that may or may not be relevant to the actual deployment in the network, the base station may query for specific CA band combinations. The base station query may also request capabilities relating to the combination of specific capabilities that the carrier's network supports. Among others, such capabilities may include DL/UL BW class, MIMO capability, TM3-4 MIMO capability, Dual Connectivity support, simultaneous RxTx, supported CSI-RS processes, etc.

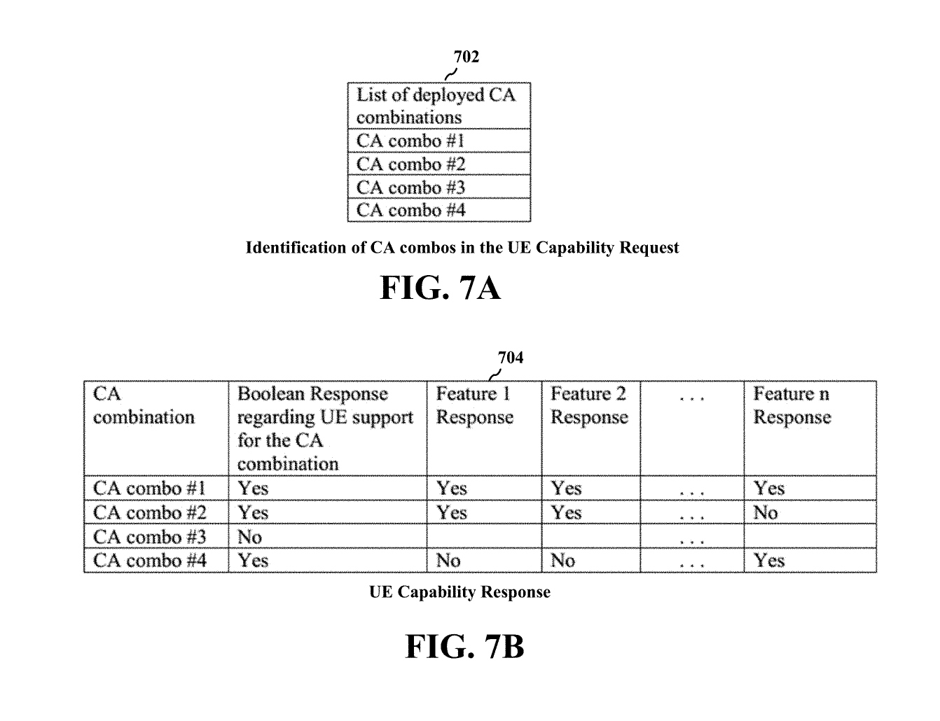

For example, the base station may send a list of multiple CA band combinations for which the UE is requested to report information on the UE's capabilities for the CA band combinations. FIG. 7A illustrates an example list, where the base station indicates that the UE should respond letting the base station know whether the UE supports CA band combination #1, CA band combination #2, CA band combination #3, and/or CA band combination #4. The list may indicate all CA band combinations that are actually deployed in the network, or may indicate a subset of CA band combinations that the network deploys for which the base station is interested in knowing the UE Capability. The base station may also indicate in the list a set of network-specific features corresponding to the CA band combinations that the carrier's network supports.

In one example, illustrated in FIG. 7B, the UE may indicate a Boolean type response letting the eNB know whether UE supports the indicated CA band combinations. As illustrated, the UE may indicate yes/no or true/false using a Boolean type response for each of the CA band combinations in relation to which the base station requests capabilities information. The Boolean type response may be included in a UE Capability Information message. Additionally, the UE may include a response for the set of network-specific features for each of the CA band combinations that the UE supports. For example, the UE may send a bitstring to the eNB with each bit indicating whether or not the UE supports a particular feature from the set of network-specific features for the corresponding CA band combination.

For example, the UE Capability Enquiry message may include a dynamic length bitstring for each network requested CA band combination that provides a list of network-specific features supported for the CA band combinations. Each bit in the bitstring may correspond to a specific feature supported for at least one CA band combination. One common bitstring may be used for all of the CA band combinations supported by the network. Thus, the common bitstring may include a bit to indicate all of the features supported for any of the supported CA band combinations. The bitstring is a dynamic length bitstring, because its length depends on the number of features supported by the network. As an alternative, individual dynamic length bitstrings may be sent for each CA band combination, having a bit for each feature supported for that individual CA band combination. As another example, a bitstring may be sent for a subset of the CA combinations supported by the network, e.g., for CA band combinations with common supported features. A bitmap may also be used to indicate the features.

Tables 1-6 provide example bitstrings. In each of these tables, the leftmost bit corresponds to Bit 1. Reserved bits may be allocated to provide the ability to include additional features in the future. Table 1 describes a CA band combination specific feature bitstring. The bitstring transmitted to a UE may have a dynamic length up to 8 bits. Although this example is described for a length of 8 bits, the length may be n bits, with the bits number from 0 to n−1, for example. In the response from the UE, a “1” may indicate that the feature is supported for a specific CA band combination, and a “0” may indicate that the feature is not supported for a specific CA band combination.

TABLE 1

| CA Band Combination level | |
|---|---|
| Feature Bit Number | Description |
| 1 | multipleTimingAdvance |
| 2 | simultaneousRx-Tx |
| 3 | DC support-Asynchronous |
| 4 | Reserved |
| 5 | Reserved |
| 6 | Reserved |
| 7 | Reserved |
| 8 | Reserved |

Tables 2-6 describes examples of band-specific feature bitstrings that may be applicable to each band in a CA band combination. Table 2 shows an exemplary bitstring such as may be used to signal capabilities in relation to a DL bandwidth class feature. An UL bandwidth class feature bitstring could be similar to the bitstring in Table 2. In Table 2, an indication of “DL Bandwidth class A” means the UE supports non-contiguous CA on this band with aggregated bandwidth having not more than 100 resource blocks (<=NRB100), NRB being the number of resource blocks; “DL Bandwidth class B” means the UE supports contiguous CA that includes two component carrier on this band with NRB25<aggregated bandwidth<=NRB100; “DL Bandwidth class C” means the UE supports contiguous CA that includes two component carriers on this band with NRB100<aggregated bandwidth<=NRB200; “DL Bandwidth class D” means the UE supports contiguous CA that includes three component carriers on this band with NRB200<aggregated bandwidth<=NRB300; and “DL Bandwidth class E” means the UE supports contiguous CA that includes two component carrier on this band with NRB300<aggregated bandwidth<=NRB400.

TABLE 2

| CA Band level Feature Bit Number | Description |
|---|---|
| 1 | DL Bandwidth Class A |
| 2 | DL Bandwidth Class B |
| 3 | DL Bandwidth Class C |
| 4 | DL Bandwidth Class D |
| 5 | DL Bandwidth Class E |
| 6 | Reserved |
| 7 | Reserved |
| 8 | Reserved |

Table 3 shows an example bitstring such as may be used to signal capabilities in relations to a DL MIMO layer feature. DL MIMO 2L means, e.g., that the network supports 2 layer MIMO on the DL for the CA band combination. Similarly, DL MIMO 4L and DL MIMO 8L mean that the network supports 4 layer or 8 layer MIMO on the DL for the CA band combinations.

TABLE 3

| CA Band level Feature Bit Number | Description |
|---|---|
| 1 | DL MIMO 2L |
| 2 | DL MIMO 4L |
| 3 | DL MIMO 8L |
| 4 | Reserved |
| 5 | Reserved |
| 6 | Reserved |
| 7 | Reserved |
| 8 | Reserved |

Table 4 shows an example UL MIMO layer feature bitstring.

TABLE 4

| CA Band level Feature Bit Number | Description |
|---|---|
| 1 | UL MIMO 2L |
| 2 | UL MIMO 4L |
| 3 | Reserved |
| 4 | Reserved |
| 5 | Reserved |
| 6 | Reserved |
| 7 | Reserved |
| 8 | Reserved |

Table 5 shows an example of supported CSI processes feature bitstring. In this table, n1, n3, and n4 represent the number of CSI processes supported on a CC within a band. Value n1 corresponds to a 1 CSI process, n3 corresponds to 3 CSI processes, n4 corresponds to 4 CSI processes.

TABLE 5

| CA Band level Feature Bit Number | Description |
|---|---|
| 1 | n1 |
| 2 | n3 |
| 3 | n4 |
| 4 | Reserved |
| 5 | Reserved |
| 6 | Reserved |
| 7 | Reserved |
| 8 | Reserved |

Table 6 describes an example feature bitstring for other bands. The entry FourLayerTM3-TM4-per-CC represents whether the UE supports 4-layer spatial multiplexing for transmission mode 3 (TM3) and transmission mode 4 (TM4) for the CC in the CA band combination.

TABLE 6

| CA Band level Feature Bit | |
|---|---|
| Number | Description |
| 1 | FourLayerTM3-TM4-per-CC |
| 2 | Reserved |
| 3 | Reserved |
| 4 | Reserved |
| 5 | Reserved |
| 6 | Reserved |
| 7 | Reserved |
| 8 | Reserved |

Although the examples above describe an 8 bit bitstring, another size bitstring might also be used, e.g., with a different number of defined and/or reserved bits. The enquiry from the base station may comprise a dynamic length, e.g., according to the CA bands and features supported by the network.

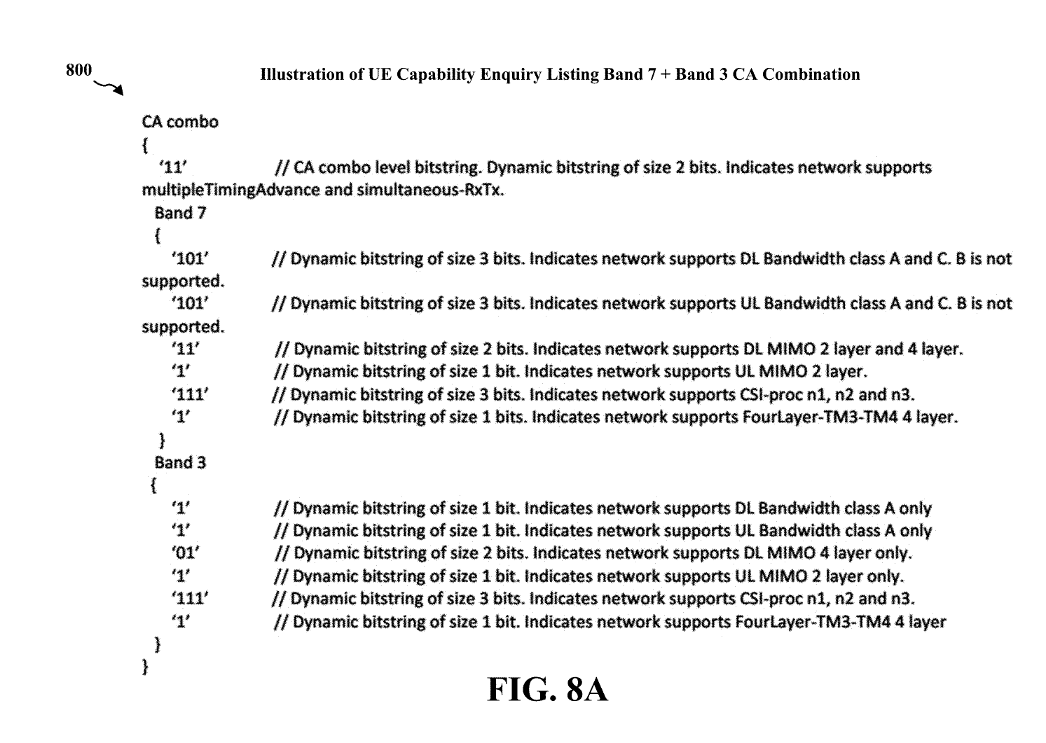

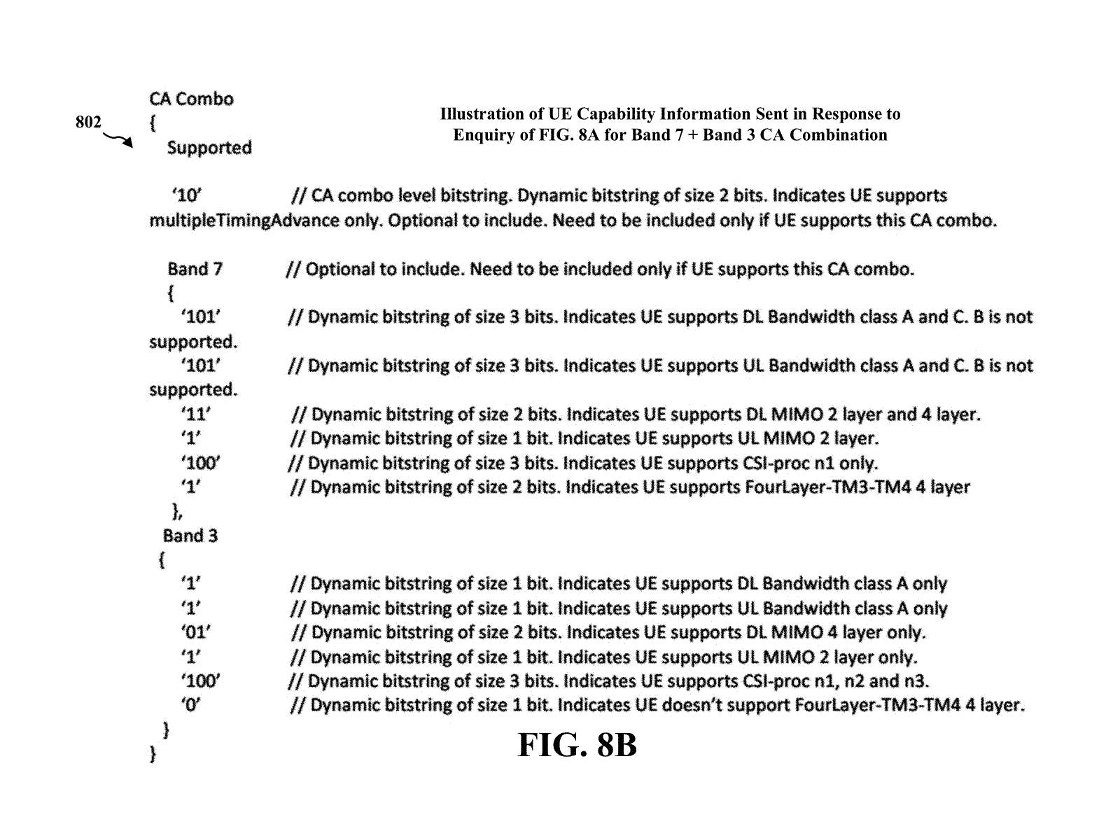

FIG. 8A illustrates an example feature bitstring for a UE Capability Enquiry for a Band 7 and Band 3 combination. This bitstring may be sent by the network. In response, a UE may provide the bitstring illustrated in FIG. 8B showing whether it supports the features indicated in the bitstring in FIG. 8A. In the response from the UE, a “1” may indicate that the feature is supported for a specific band in a specific CA band combination, and a “0” may indicate that the feature is not supported for the specific band in the specific CA band combination.

For each network requested CA band combination, the UE may respond back with a bitstring indicating whether the UE supports the list of network-specific features that network requested in UE Capability Enquiry message. The length of the UE's response bitstring may be the same as that of the bitstring received from the eNB. The format of the bitstrings may be defined. Each bit in a bitstring may correspond to a CA combo feature and may indicate whether the UE supports that feature for the specific CA combo or not. Thus, the bitstring may have a dynamic length, the length being determined by the network according to the number of network supported features for each of the CA band combinations. The set of features may include all of the network supported features for the CA band combinations. As another example, the set of features in the request may include a subset of network supported features.

FIG. 8B illustrates an example bitstring response for the UE Capability message from the UE in response to receiving the feature bitstring of FIG. 8A. Similar to the enquiry, the response from the UE may comprise a dynamic length, e.g., according to the CA bands and features for which the UE responds.

The set of features may be indicated by the base station individually for each of the CA combinations in the request. In another example, the base station may send a set of features, e.g., using the bitstring or a bitmap, that are common to multiple CA combinations indicated by the base station. In yet another example, the base station may send a set of features that is common to all of the CA combinations that the base station indicates to the UE.

Features for the CA combinations may include DL/UL Bandwidth class, DL MIMO layer, DL TM3/4 MIMO layer, UL MIMO layer, Dual Connectivity support, simultaneous RxTx, supported CSI-RS proc, etc.

If there are 32 defined features for each combo, the UE may use a Boolean (TRUE/FALSE or YES/NO) to indicate whether the UE supports the CA band combination. If the UE responds YES that it does support the CA band combination, then the UE includes a 32-bit (or other dynamic length bitstring based on the network indication) that indicates the support for each of the features for the CA band combination. Furthermore, the UE may refrain from sending a bitstring for any CA band combination for which the UE replies NO that the UE does not support the CA combination.

By using a UE capability request that specifies network supported features, such as supported CA band combinations and/or a set of network-specific features, for which the UE should report the UE's capabilities, the network can tailor the request to the specific set of features that the network deploys.

Even though the size of the UE Capability Enquiry message may be increased in order to indicate CA band combinations and corresponding network supported features to the UE, the increase in size is balanced by a decrease in the size of the UE capability information transmitted by the UE, especially when the number of CA band combinations deployed by a carrier is much less than the number of CA band combinations that a UE device might support. The leads to a reduction in transmission time of the UE Capability information message.

The UE response may also be structured so that the UE is not required to construct and send large UL signaling messages for advertising UE Capability. In one example, the UE may send a Boolean type response for each CA band combination. The UE may also use a bitmap or bitstring in the response to indicate whether the UE supports the network specific set of features associated with the CA band combinations.

The aspects presented herein are different than having a network merely indicate a prioritization of bands that may be used by the UE to adjust the order in which the UE transmits its capabilities. While a prioritization may change the order in which the UE transmits the UE capabilities, the prioritization does not change the amount of information that is transmitted by the UE. Thus, the UE will continue to send a large amount of information that may not be pertinent to the network.

The aspects presented herein are also different than merely setting an upper limit on the amount of UE capabilities that are reported by the UE. Such a limit will reduce the amount of UE capability information, but the UE may still transmit unnecessary information to the network, e.g., regarding CA band combinations that are not deployed by the network. Further, such a limit may cause a UE to fail to report CA band combinations and capabilities that are pertinent to a particular network.

The aspects presented herein are also different than a base station indicating bands that it deploys and having the UE report CA band combinations for the deployed bands. Such type of limitation can still lead to unnecessary UE capability information, because the bands used by the network may correspond to a large number of potential CA band combinations, of which the network may only deploy a subset. While the amount of CA band combinations for which the UE sends capability information may be reduced, the network cannot direct the UE to respond with targeted UE capability information for CA combinations that are deployed by the network operator. Limiting the UE capability to certain bands reduces UE capability reporting that is unrelated to the network, but may cause a substantial amount of unnecessary information to be sent to the network. Furthermore, aspects presented herein, enable the eNB to pull a response from the UE regarding a network-specific set of features supported for the CA band combinations deployed by the network, which cannot be accomplished by the network indicating a band.

A network may need to continue to communicate with and use UE capability messages from legacy UEs, which are not capable of responding to the targeted request from the network. Thus, the request from the base station may be formatted so that the request may be interpreted by legacy UEs as a standard UE capability enquiry to which the UE will respond with all of the UE's capabilities, e.g., without limitation to the list of CA band combinations employed by the network. In another example, an base station may send a first type of UE capability enquiry to a first type of UE and a second type of UE capability enquiry to a second type of UE. For example, the base station may transmit a legacy type UE capability enquiry to legacy UEs which are not capable of responding for a list of CA band combinations and may send the UE capability enquiry with a list of CA combinations to UEs that are capable of responding with such targeted UE capability information.

UE capabilities may change, and/or network deployments may change that may need a new query. In order for the UE to report this change in UE capabilities to the network, the base station may again send a UE capability enquiry with CA band combinations to which the UE will respond with the UE's capabilities for each of the CA related aspects employed by the network. This may involve a disconnection and reconnection by the UE in order to notify the network of the change in UE capabilities.

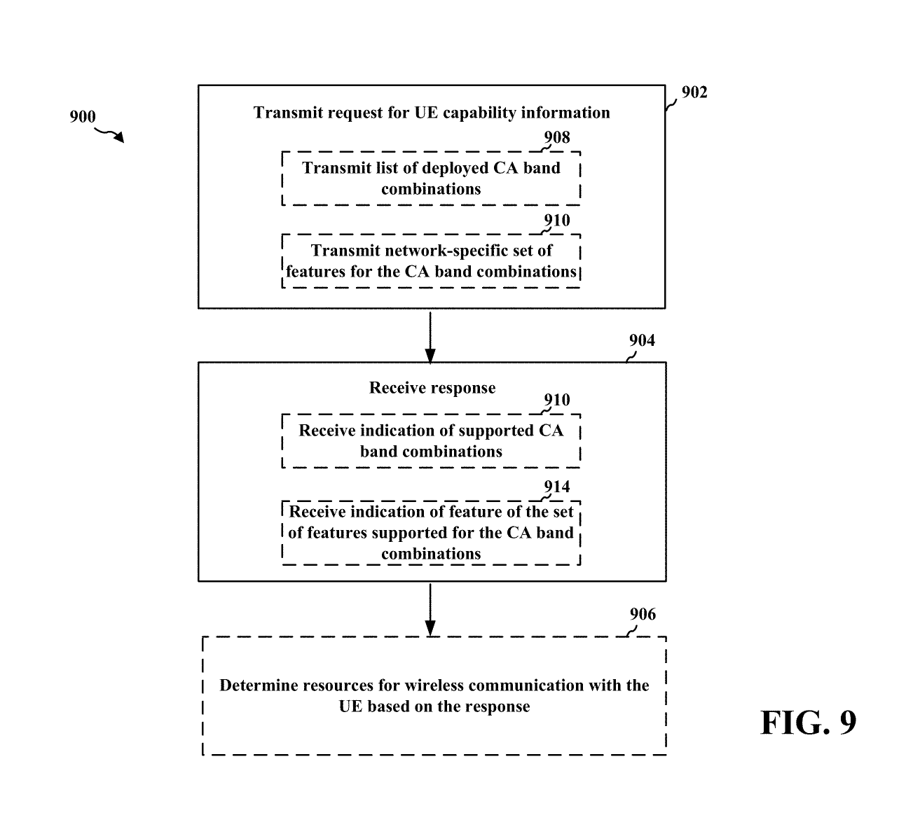

FIG. 9 is a flowchart 900 of a method of wireless communication. Optional aspects are illustrated having a dashed line. The method may be performed by a base station (e.g., base station 102, 180, 310, 604, 1350, the apparatus 1002/1002′). At 902, the base station may transmit a request to a UE, e.g., UE 104, 350, 1050 or apparatus 1302, 1302′, for UE capability information, the request indicating at least one network supported UE capability. The request may comprise a UE Capability Enquiry, for example.

As illustrated at 908, the request may specify a plurality of CA band combinations associated with a wireless communication network, such as a listing of each CA combination deployed by the wireless network operator or a subset of CA band combinations deployed by the wireless network operator.

The request at 902 may comprise a dynamic length, e.g., based on the UE capabilities supported by the network. For example, the length of the request at 902 may be based on the CA band combinations indicated in the request (e.g., which may vary based on the CA band combinations supported by the network) and/or a network-specific set of features corresponding to the plurality of CA band combinations and indicated in the request.

At 904, a response may be received from a UE indicating UE support for the at least one indicated network supported UE capability. The response may comprise a UE Capability Information message. For example, when the request includes a plurality of CA band combinations at 908, the response at 904 may comprise, for each CA band combination in the plurality of CA band combinations, an indication 910 of whether the CA band combination is supported by the UE. The response may comprise a Boolean type response indicating whether the UE supports the at least one CA band combination, e.g., as described in connection with FIGS. 7A and 7B.

Similar to the request, the response may have a dynamic length.

The request for UE capability information may comprise a request for first UE capabilities determined by the network and second UE capabilities common to a plurality of networks accessible by the UE, and wherein transmitting the response comprises indicating support for the first UE capabilities and the second UE capabilities. The indication of support for the first UE capabilities may include an indication of support for each first UE capability and for one or more features corresponding to said each first UE capability.

Thus, the UE may refrain from transmitting a second indication indicating capability for UE capabilities different than the at least one network supported UE capability indicated in the request.

The request at 910 (as part of 902) may further comprise a network-specific set of features corresponding to the plurality of CA band combinations. Then, the response at 914 (as part of 904) may comprise a separate indication of support or a lack of support for each feature in the set of network-specific features when operating in the plurality of CA band combinations. The set of features may comprise one or more of the following with respect to the plurality of CA band combinations: a MIMO capability of the UE, a simultaneous RX/TX capability of the UE, support for dual-connectivity, and support for Channel State Information-Reference Signal (CSI-RS) procedure. The response may indicate UE capabilities corresponding to the at least one network supported UE capability and might not indicate UE capabilities different than the at least one network supported CA capability.

The plurality of CA band combinations may comprise band combinations supported by a wireless communication network and the network-specific set of features may comprise features supported by the network on at least one of the plurality of CA band combinations. The network-specific set of features may comprise a plurality of subsets, wherein each subset is associated with at least one CA band combination of the plurality of CA band combinations, and wherein the separate indication of support or a lack of support corresponds to features of the subset associated with the at least one CA band combination.

The response may comprise a bit string corresponding to the network-specific set of features for each CA band combination in the plurality of CA band combinations supported by the UE. The bit string may comprise a fixed length bit string or a dynamic/variable length bit string. Each bit of the bit string may indicate support or lack of support for a corresponding feature in the network-specific set of features.

The network-specific set of features may comprise a first bit string indicating the network-specific set of features supported for at least one of the plurality of CA band combinations and the response from the UE may include a second bit string indicating whether the UE supports each of the features in the network-specific set of features, wherein the first bit string and the second bit string have a same length.

Although this example is described for a bit string, the feature indication may also be configured as a bitmap. Each bit of the bitstring or bitmap may correspond to a network-supported feature for at least one of the deployed CA band combinations. Additional details of a possible bitstring or bitmap are described in connection with Tables 1-6 and FIGS. 8A and 8B.

Each bit of the first bit string may correspond to one feature of the network-specific set of features, and each bit of the second bit string may indicate whether the UE supports the corresponding feature.

The response from the UE may comprise a separate indication of support or a lack of support for each feature in the set of network-specific features for each of the plurality of CA band combinations supported by the UE.

The network-specific set of features may be common to each CA band combination in the plurality of CA combinations. Therefore, the network may send a plurality of CA band combinations and a single bitstring with a bit for each feature supported for any of the plurality of CA band combinations.

The base station may use then UE capability in configuring the UE. For example, at 906, the base station may determine resources for wireless communication with the

UE based at least in part on the UE capability response.

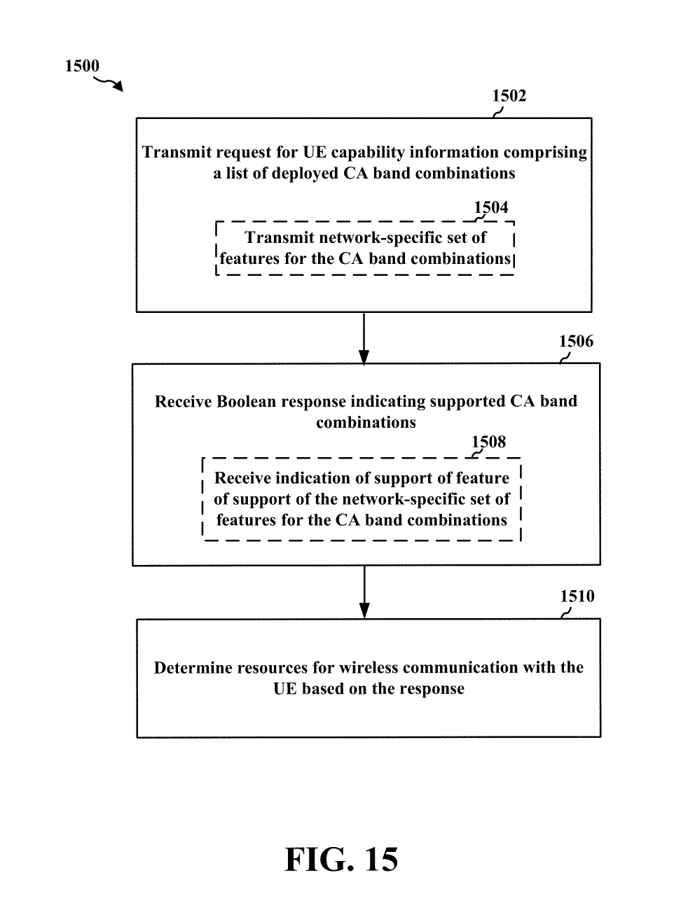

FIG. 15 illustrates a flowchart 1500 of a method of wireless communication as in FIG. 9, where the network supported UE capability comprises a list of deployed CA band combinations. Optional aspects are illustrated having a dashed line. The method may be performed by an base station (e.g., the base station 102, 180, 310, 604, 1350, the apparatus 1002/1002′). At 1502, the base station may transmit a request to a UE, e.g., UE 104, 350, 1050 or apparatus 1302, 1302′, for UE capability information, the request comprising an indication of at least one CA band combination supported by the network, e.g., a listing of each CA combination deployed by the wireless network operator or a subset of CA band combinations deployed by the wireless network operator. The request may comprise a UE Capability Enquiry, for example. As illustrated at 1504, the request may further comprise a network-specific set of features corresponding to the at least one CA band combination.

The request at 1502 may comprise a dynamic length, e.g., based on the CA band combinations indicated in the request (e.g., which may vary based on the CA band combinations supported by the network) and/or a network-specific set of features corresponding to the plurality of CA band combinations and indicated in the request.

At 1506, a response may be received from a UE indicating UE support for each of the at least one indicated network supported CA band combination. The response may comprise a UE Capability Information message. The response may comprise a Boolean type response indicating whether the UE supports the at least one CA band combination, e.g., as described in connection with FIGS. 7A and 7B.

When the request includes a network specific set of features supported for indicated the CA band combination(s), the response at 1508 (as part of 1506) may comprise a separate indication of support or a lack of support for each feature in the set of network-specific features when operating in the plurality of CA band combinations. The set of features may comprise one or more of the following with respect to the plurality of CA band combinations: a MIMO capability of the UE, a simultaneous RX/TX capability of the UE, support for dual-connectivity, and support for Channel State Information-Reference Signal (CSI-RS) procedure.

Similar to the request, the response at 1506 may have a dynamic length.

The network-specific set of features may comprise a first bit string indicating the network-specific set of features supported for at least one of the plurality of CA band combinations and the response from the UE may include a second bit string indicating whether the UE supports each of the features in the network-specific set of features, wherein the first bit string and the second bit string have a same length. Additional details of a possible bitstring or bitmap are described in connection with Tables 1-6 and FIGS. 8A and 8B, and FIG. 9.

The base station may use then UE capability in configuring the UE. For example, at 1510, the base station may determine resources for wireless communication with the UE based at least in part on the UE capability response.

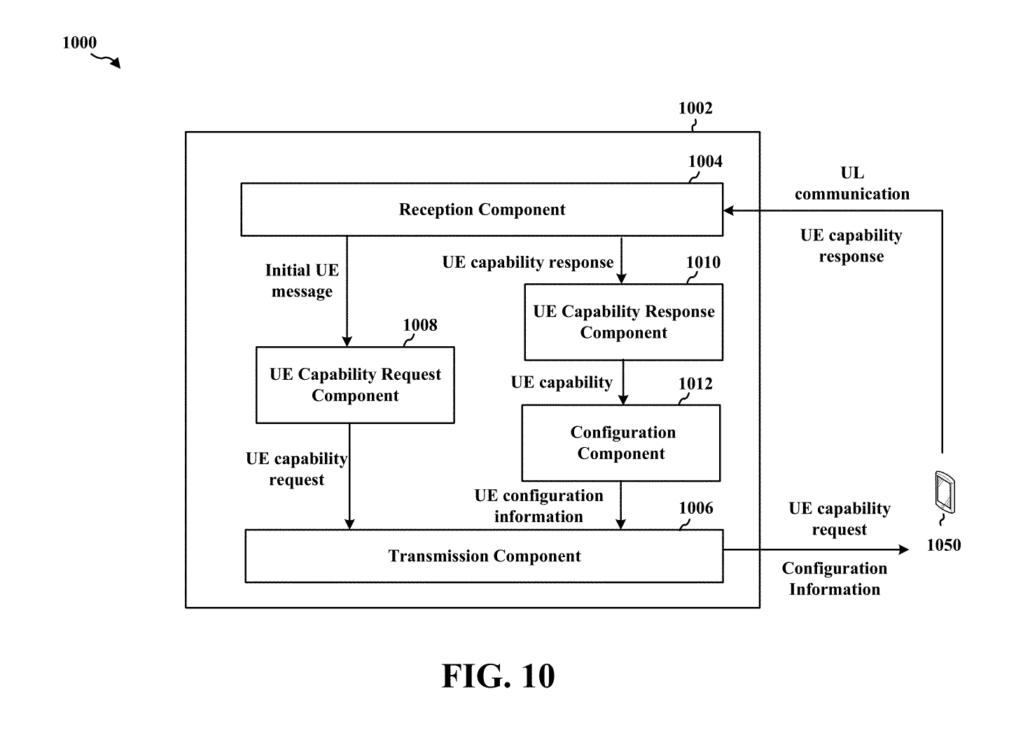

FIG. 10 is a conceptual data flow diagram 1000 illustrating the data flow between different means/components in an exemplary apparatus 1002. The apparatus may be an base station , e.g., such as base station 102, 180, 310, 604, 1350. The apparatus includes a reception component 1004 that receives UL communication from UE 1050 and a transmission component 1006 that transmits DL communication to UE 1050. The apparatus may include a UE capability request component 1008 that transmits a request to a UE for UE capability information, wherein the request indicates at least one supported UE capability. The apparatus may receive an initial from UE 1050. For example, the initial message may comprise a connection establishment message from the UE 1050. The reception component 1004 may provide information from this initial message to the UE capability Request Component 1008, which may then provide the UE capability request to the transmission component 1006 for transmission to the UE.

The UE may also include a UE capability response component 1010 that receives a response from the UE for the indicated at least one supported UE capability. The response may be received at the reception component 1004 and provided to the UE capability response component 1010.

The apparatus may also include a configuration component 1012 that determines resources for wireless communication with the UE based at least in part on the response. The configuration component may receive information from the UE capability response component 1010 and may provide UE configuration information to transmission component 1006 for transmission to UE 1050. The configuration information may configure the UE for CA.

The apparatus may include additional components that perform each of the blocks of the algorithm in the aforementioned flowcharts of FIGS. 6, 9 and 15. As such, each block in the aforementioned flowcharts of FIGS. 6, 9 and 15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

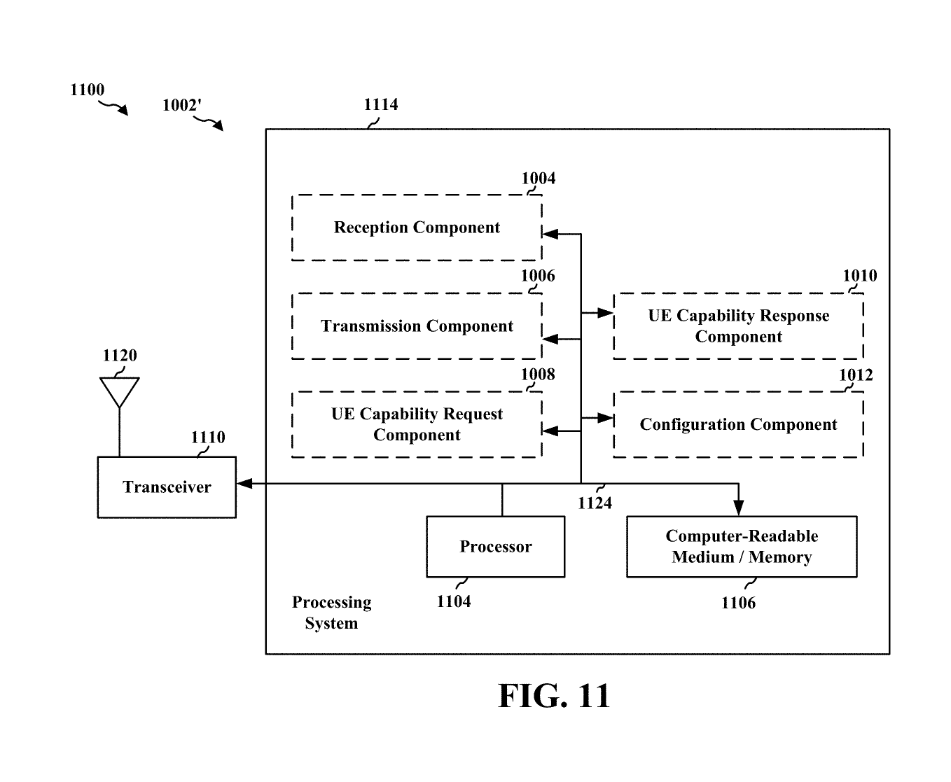

FIG. 11 is a diagram 1100 illustrating an example of a hardware implementation for an apparatus 1002′ employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware components, represented by the processor 1104, the components 1004, 1006, 1008, 1010, 1012, and the computer-readable medium/memory 1106. The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The transceiver 1110 receives a signal from the one or more antennas 1120, extracts information from the received signal, and provides the extracted information to the processing system 1114, specifically the reception component 1004. In addition, the transceiver 1110 receives information from the processing system 1114, specifically the transmission component 1006, and based on the received information, generates a signal to be applied to the one or more antennas 1120. The processing system 1114 includes a processor 1104 coupled to a computer-readable medium/memory 1106. The processor 1104 is responsible for general processing, including the execution of software stored on the computer-readable medium/memory 1106. The software, when executed by the processor 1104, causes the processing system 1114 to perform the various functions described supra for any particular apparatus. The computer-readable medium/memory 1106 may also be used for storing data that is manipulated by the processor 1104 when executing software. The processing system 1114 further includes at least one of the components 1004, 1006, 1008, 1010, 1012. The components may be software components running in the processor 1104, resident/stored in the computer readable medium/memory 1106, one or more hardware components coupled to the processor 1104, or some combination thereof. The processing system 1114 may be a component of the base station 310 and may include the memory 376 and/or at least one of the TX processor 316, the RX processor 370, and the controller/processor 375.

In one configuration, the apparatus 1002/1002′ for wireless communication includes means for transmitting a request to a UE for UE capability information indicating at least one network supported UE capability (e.g., CA band combination), means for receiving a UE capability response from the UE for the indicated at least one network supported UE capability (e.g., CA band combination), and means for determining resources for wireless communication with the UE based at least in part on the UE capability response. The aforementioned means may be one or more of the aforementioned components of the apparatus 1002 and/or the processing system 1114 of the apparatus 1002′ configured to perform the functions recited by the aforementioned means. As described supra, the processing system 1114 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

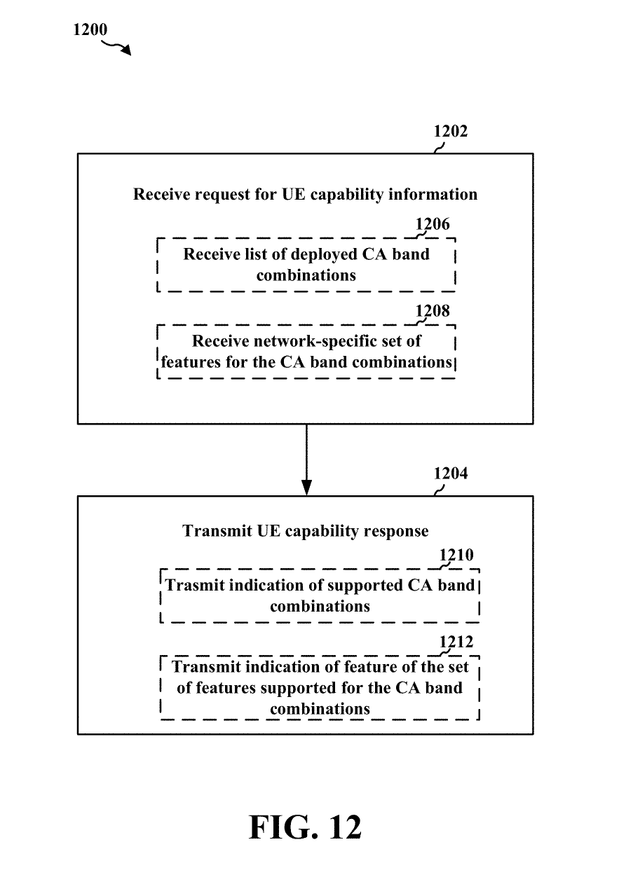

FIG. 12 is a flowchart 1200 of a method of wireless communication. The method may be performed by a UE (e.g., the UE 104/350, 602, 1050, the apparatus 1302/1302′). At 1202, the UE receives a request for UE capability information from an eNB (e.g., eNB 102, 180, 310, 604, 1350, apparatus 1002, 1002′), wherein the request indicates at least one network supported UE capability. The request may comprise a UE Capability Enquiry, for example. The request may specify a plurality of CA band combinations, such as a listing of each CA band combination deployed by a wireless communication network, e.g., at 1206.

At 1204, the UE transmits a response indicating capability for the indicated at least one network supported UE capability. The response to the request may comprise, for each specified CA band combination in the plurality of CA band combinations, an indication of whether the CA band combination is supported by the UE. The UE Capability response may comprise a UE Capability Information message, e.g., at 1210.

The request for UE capability information may comprise a request for first UE capabilities determined by the network and second UE capabilities common to a plurality of networks accessible by the UE, and the response comprises indicating support for the first UE capabilities and the second UE capabilities. The indication of support for the first UE capabilities may include an indication of support for each first UE capability and for one or more features corresponding to said each first UE capability.

Thus, the network may receive a response regarding the UE capabilities relevant to the network without a response indicating capability for UE capabilities different than the at least one network supported UE capability indicated in the request.

The request may further comprise a network-specific set of features supported by a wireless communication network and corresponding to the plurality of CA band combinations, e.g., at 1208. Then, the UE capability response may comprise a separate indication of support or a lack of support for each feature in the set of network-specific features when operating in the plurality of CA band combinations, e.g., at 1212. The set of features may comprise one or more of the following with respect to the plurality of CA band combinations: a MIMO capability of the UE, a simultaneous RX/TX capability of the UE, support for dual-connectivity, and support for Channel State Information-Reference Signal (CSI-RS) procedure

The plurality of CA band combinations may comprise band combinations supported by a wireless communication network and the network-specific set of features may comprise features supported by the network on at least one of the plurality of CA band combinations. The network-specific set of features may comprise a plurality of subsets, wherein each subset is associated with at least one CA band combination of the plurality of CA band combinations, and wherein the separate indication of support or a lack of support corresponds to features of the subset associated with the at least one CA band combination.

The response may comprise a bit string corresponding to the network-specific set of features for each CA band combination in the plurality of CA band combinations supported by the UE. The bit string may comprise a fixed length bit string or may comprise a dynamic/variable length bit string. Each bit of the bit string may indicate support or lack of support for a corresponding feature in the network-specific set of features.

The request received at 1202 may comprise a dynamic length, e.g., based on the UE capabilities supported by the network. For example, the length of the request at 902 may be based on the CA band combinations indicated in the request (e.g., which may vary based on the CA band combinations supported by the network) and/or a network-specific set of features corresponding to the plurality of CA band combinations and indicated in the request. Similar to the request, the response may have a dynamic length.

The network-specific set of features may comprise a first bit string indicating the network-specific set of features supported for at least one of the plurality of CA band combinations and the response from the UE may include a second bit string indicating whether the UE supports each of the features in the network-specific set of features, wherein the first bit string and the second bit string have a same length.

Although this example is described for a bit string, the feature indication may also be configured as a bitmap.

Each bit of the first bit string may correspond to one feature of the network-specific set of features, and each bit of the second bit string may indicate whether the UE supports the corresponding feature.

The response from the UE may comprise a separate indication of support or a lack of support for each feature in the set of network-specific features for each of the plurality of CA band combinations supported by the UE.

The network-specific set of features may be common to each CA band combination of the plurality of CA combinations.

The response may comprise a Boolean type response indicating whether the UE supports the at least one CA band combination, e.g., as described in connection with FIGS. 7A and 7B.

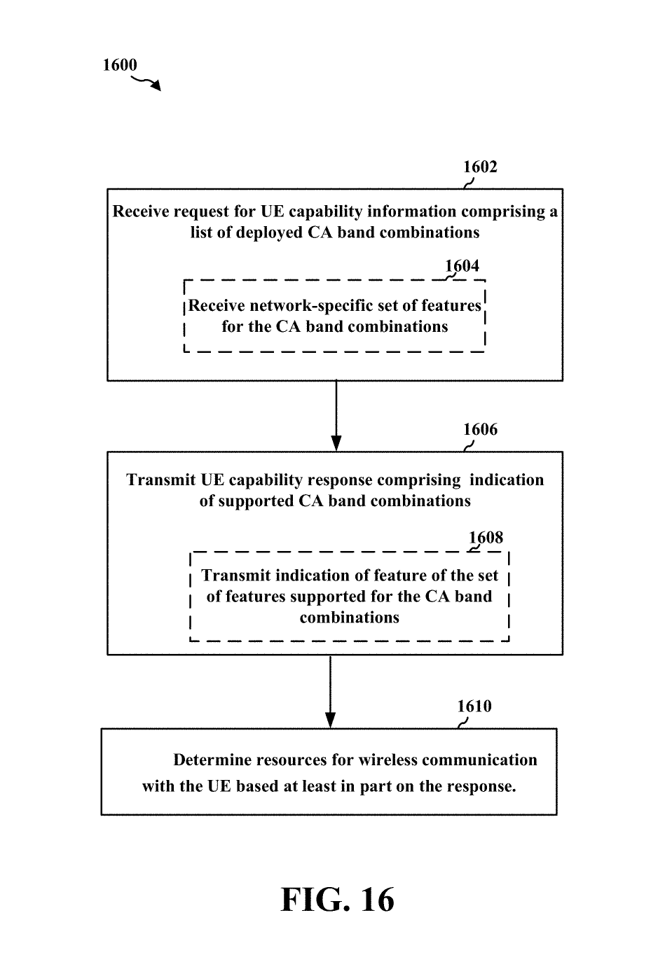

FIG. 16 is a flowchart 1600 of an example method of wireless communication, as in FIG. 12. The method may be performed by a UE (e.g., the UE 104/350, 602, 1050, the apparatus 1302/1302′). At 1602, the UE receives a request for UE capability information from an eNB (e.g., eNB 102, 180, 310, 604, 1350, apparatus 1002, 1002′), wherein the request indicates at least one network supported CA band combination. The request may specify a plurality of CA band combinations, such as a listing of each CA band combination deployed by a wireless communication network. The request may comprise a UE Capability Enquiry, for example. The request received at 1602 may comprise a dynamic length, e.g., based on the UE capabilities supported by the network. Similar to the request, the response may have a dynamic length.

At 1606, the UE transmits a response indicating capability for the indicated at least one network supported CA band combination. The response to the request may comprise, for each specified CA band combination in a plurality of CA band combinations, an indication of whether the CA band combination is supported by the UE. The UE Capability response may comprise a UE Capability Information message, e.g., at 1210.

The response may comprise a Boolean type response indicating whether the UE supports the at least one CA band combination, e.g., as described in connection with FIGS. 7A and 7B. Similar to the request, the response may have a dynamic length.

Thus, the network may receive a response regarding the UE capabilities relevant to the CA band combinations supported by the network without a response indicating capability for CA band combinations different than the at least one network supported CA band combinations indicated in the request.

The request may further comprise a network-specific set of features supported by a wireless communication network and corresponding to each of the plurality of CA band combinations, e.g., at 1604. Then, the UE capability response may comprise a separate indication of support or a lack of support for each feature in the set of network-specific features when operating in the plurality of CA band combinations, e.g., at 1608. The set of features may comprise one or more of the following with respect to the plurality of CA band combinations: a MIMO capability of the UE, a simultaneous RX/TX capability of the UE, support for dual-connectivity, and support for Channel State Information-Reference Signal (CSI-RS) procedure

The plurality of CA band combinations may comprise band combinations supported by a wireless communication network of the base station and the network-specific set of features may comprise features supported by the network on at least one of the plurality of CA band combinations. The network-specific set of features may comprise a plurality of subsets, wherein each subset is associated with at least one CA band combination of the plurality of CA band combinations, and wherein the separate indication of support or a lack of support corresponds to features of the subset associated with the at least one CA band combination.

The response may comprise a bit string, as described in connection with FIG. 12.

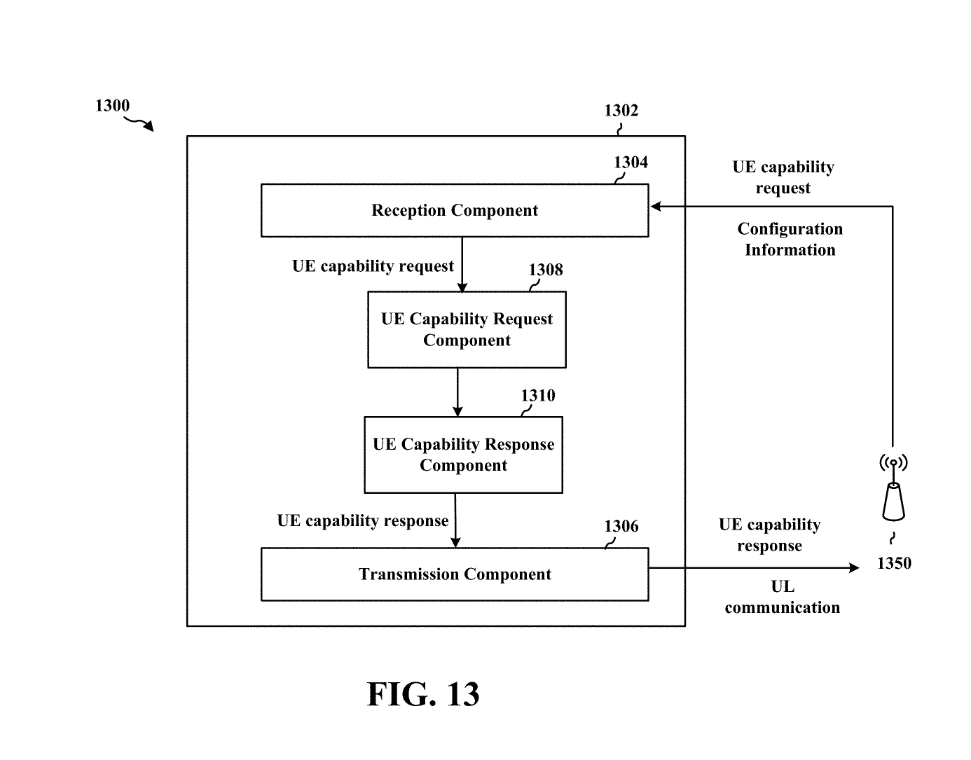

FIG. 13 is a conceptual data flow diagram 1300 illustrating the data flow between different means/components in an exemplary apparatus 1302. The apparatus may be a UE (e.g., the UE 104/350, 602, 1050, the apparatus 1302/1302′). The apparatus includes a reception component 1304 that receives DL communication from eNB 1350 (e.g., eNB 102, 180, 310, 604, 1350, apparatus 1002, 1002′) and a transmission component 1306 that transmits UL communication to eNB 1350. The apparatus includes a UE capability request component 1308 that receives a request for UE capability information, wherein the request indicates at least one network supported UE capability. The reception component 1304 may receive the request from eNB 1350 and provide the request to the UE capability request component 1308. The apparatus may also include a UE capability response component 1310 that transmits a response indicating capability for the indicated at least one network supported UE capability, in response to the request received at the UE capability request component 1308. The UE capability response component 1310 may provide the response to the transmission component for transmission to the eNB 1350. The eNB may respond to the apparatus with configuration information, e.g., for CA, which the apparatus may then use in communicating with eNB 1350.

The apparatus may include additional components that perform each of the blocks of the algorithm in the aforementioned flowcharts of FIGS. 6, 12, 16. As such, each block in the aforementioned flowcharts of FIGS. 6, 12, 16 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

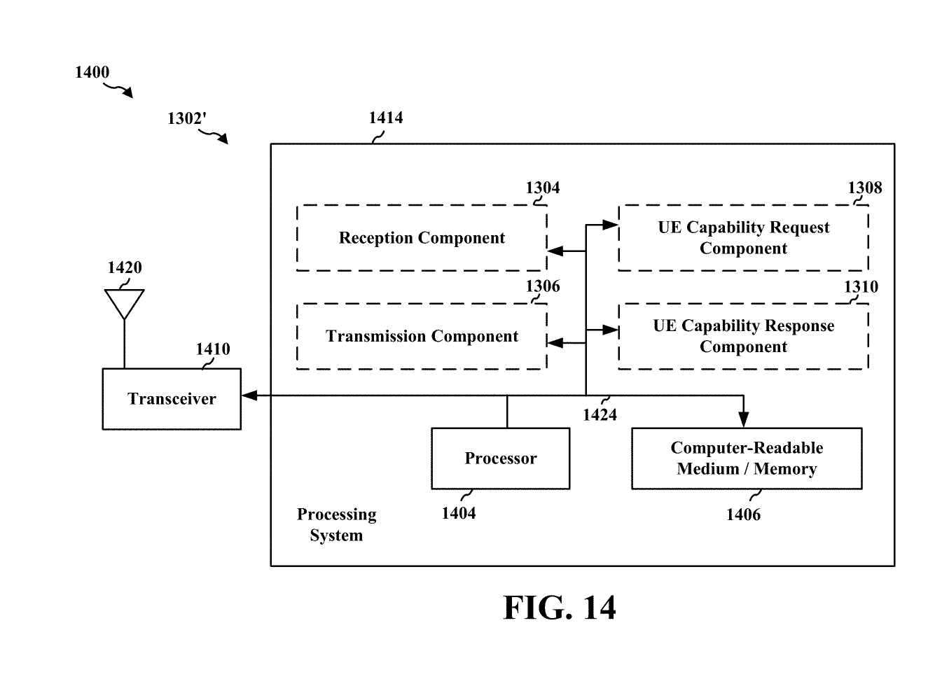

FIG. 14 is a diagram 1400 illustrating an example of a hardware implementation for an apparatus 1302′ employing a processing system 1414. The processing system 1414 may be implemented with a bus architecture, represented generally by the bus 1424. The bus 1424 may include any number of interconnecting buses and bridges depending on the specific application of the processing system 1414 and the overall design constraints. The bus 1424 links together various circuits including one or more processors and/or hardware components, represented by the processor 1404, the components 1304, 1306, 1308, 1310, and the computer-readable medium/memory 1406. The bus 1424 may also link various other circuits such as timing sources, peripherals, voltage regulators, and power management circuits, which are well known in the art, and therefore, will not be described any further.

The processing system 1414 may be coupled to a transceiver 1410. The transceiver 1410 is coupled to one or more antennas 1420. The transceiver 1410 provides a means for communicating with various other apparatus over a transmission medium. The transceiver 1410 receives a signal from the one or more antennas 1420, extracts information from the received signal, and provides the extracted information to the processing system 1414, specifically the reception component 1304. In addition, the transceiver 1410 receives information from the processing system 1414, specifically the transmission component 1306, and based on the received information, generates a signal to be applied to the one or more antennas 1420. The processing system 1414 includes a processor 1404 coupled to a computer-readable medium/memory 1406. The processor 1404 is responsible for general processing, including the execution of software stored on the computer-readable medium/memory 1406. The software, when executed by the processor 1404, causes the processing system 1414 to perform the various functions described supra for any particular apparatus. The computer-readable medium/memory 1406 may also be used for storing data that is manipulated by the processor 1404 when executing software. The processing system 1414 further includes at least one of the components 1304, 1306, 1308, 1310. The components may be software components running in the processor 1404, resident/stored in the computer readable medium/memory 1406, one or more hardware components coupled to the processor 1404, or some combination thereof. The processing system 1414 may be a component of the UE 350 and may include the memory 360 and/or at least one of the TX processor 368, the RX processor 356, and the controller/processor 359.

In one configuration, the apparatus 1302/1302′ for wireless communication includes means for receiving a request for UE capability information, the request indicating at least one network supported UE capability (e.g., CA band combination(s)) and means for transmitting a UE capability response for the indicated at least one network supported UE capability (e.g., CA band combination(s)). The aforementioned means may be one or more of the aforementioned components of the apparatus 1302 and/or the processing system 1414 of the apparatus 1302′ configured to perform the functions recited by the aforementioned means. As described supra, the processing system 1414 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication at a user equipment (UE), comprising:
receiving a request for UE capability information, wherein the request indicates at least one network-supported UE capability; and
transmitting a response indicating a capability for the indicated at least one network-supported UE capability.

2. The method of claim 1, wherein the request specifies a plurality of carrier aggregation (CA) band combinations associated with a wireless communication network, and
wherein the response to the request comprises, for each specified CA band combination in the plurality of CA band combinations, an indication of whether the specified CA band combination is supported by the UE.

3. The method of claim 2, wherein the response comprises a Boolean type response indicating whether the UE supports each of the plurality of CA band combinations.

4. The method of claim 2, wherein the request comprises a set of network-specific features supported by the wireless communication network and corresponding to the plurality of CA band combinations, and
wherein the response to the request further comprises a separate indication of support or a lack of support for each feature in the set of network-specific features when operating in the plurality of CA band combinations.

5. The method of claim 4, wherein the set of network-specific features comprises one or more of the following with respect to the plurality of CA band combinations: a MIMO capability of the UE, a simultaneous RX/TX capability of the UE, support for dual-connectivity, and support for Channel State Information-Reference Signal (CSI-RS) procedure.

6. The method of claim 4, wherein the response comprises a bit string corresponding to the set of network-specific features for each CA band combination in the plurality of CA band combinations supported by the UE.

7. The method of claim 4, wherein the plurality of CA band combinations are supported by the wireless communication network and the set of network-specific features are supported by the wireless communication network on at least one of the plurality of CA band combinations.

8. The method of claim 4, wherein the set of network-specific features comprises a plurality of subsets, wherein each subset is associated with at least one CA band combination of the plurality of CA band combinations, and wherein the separate indication of support or a lack of support corresponds to features of the subset associated with the at least one CA band combination.

9. The method of claim 4, wherein the set of network-specific features comprises a first bit string indicating the set of network-specific features supported for at least one of the plurality of CA band combinations and the response from the UE includes a second bit string indicating whether the UE supports each feature in the set of network-specific features, wherein the first bit string and the second bit string have a same length.

10. The method of claim 9, wherein each bit of the first bit string corresponds to one feature of the set of network-specific features, and wherein each bit of the second bit string indicates whether the UE supports the corresponding feature.

11. The method of claim 4, wherein the response from the UE comprises a separate indication for the set of network-specific features for each of the plurality of CA band combinations supported by the UE.

12. The method of claim 1, further comprising:
refraining from transmitting a second indication of capability for UE capabilities different than the at least one network supported UE capability indicated in the request.

13. An apparatus for wireless communication at a user equipment (UE), comprising:
means for receiving a request for UE capability information, wherein the request indicates at least one network supported UE capability; and
means for transmitting a response indicating capability for the indicated at least one network supported UE capability.

14. The apparatus of claim 13, wherein the request specifies a plurality of carrier aggregation (CA) band combinations associated with a wireless communication network, and
wherein the response to the request comprises, for each specified CA band combination in the plurality of CA band combinations, an indication of whether the specified CA band combination is supported by the UE.

15. The apparatus of claim 14, wherein the response comprises a Boolean type response indicating whether the UE supports each of the plurality of CA band combinations.

16. The apparatus of claim 14, wherein the request comprises a set of network-specific features supported by the wireless communication network and corresponding to the plurality of CA band combinations, and
wherein the response to the request further comprises a separate indication of support or a lack of support for each feature in the set of network-specific features when operating in the plurality of CA band combinations.

17. The apparatus of claim 13, wherein the response indicates UE capabilities corresponding to the at least one network supported UE capability and does not indicate UE capabilities different than the at least one network supported UE capability.

18. An apparatus for wireless communication at a user equipment (UE), comprising:
a memory; and
at least one processor coupled to the memory and configured to:
receive a request for UE capability information, wherein the request indicates at least one network supported UE capability; and
transmit a response indicating capability for the indicated at least one network supported UE capability.

19. The apparatus of claim 18, wherein the request specifies a plurality of carrier aggregation (CA) band combinations associated with a wireless communication network, and
wherein the response to the request comprises, for each specified CA band combination in the plurality of CA band combinations, an indication of whether the specified CA band combination is supported by the UE.

20. The apparatus of claim 19, wherein the response comprises a Boolean type response indicating whether the UE supports each of the plurality of CA band combinations.

21. The apparatus of claim 19, wherein the request comprises a set of network-specific features supported by the wireless communication network and corresponding to the plurality of CA band combinations, and
wherein the response to the request further comprises a separate indication of support or a lack of support for each feature in the set of network-specific features when operating in the plurality of CA band combinations.

22. The apparatus of claim 18, wherein the response indicates UE capabilities corresponding to the at least one network supported UE capability and does not indicate UE capabilities different than the at least one network supported UE capability.

23. A computer-readable medium storing computer executable code, comprising code to:
receive a request for UE capability information, wherein the request indicates at least one network supported UE capability; and
transmit a response indicating capability for the indicated at least one network supported UE capability.

24. A method of wireless communication by a base station, comprising:
transmitting a request to a user equipment (UE) for UE capability information, wherein the request indicates at least one network supported UE capability; and
receiving a response from the UE for the indicated at least one supported UE capability.

25. The method of claim 24, wherein the request specifies a plurality of carrier aggregation (CA) band combinations associated with a wireless communication network of the base station, and
wherein the response to the request comprises, for each specified CA band combination in the plurality of CA band combinations, an indication of whether the specified CA band combination is supported by the UE.

26. The method of claim 25, wherein the response comprises a Boolean type response indicating whether the UE supports each of the plurality of CA band combinations.

27. The method of claim 25, wherein the request comprises a set of network-specific features supported by the wireless communication network and corresponding to the plurality of CA band combinations, and
wherein the response to the request further comprises a separate indication of support or a lack of support for each feature in the set of network-specific features when operating in the plurality of CA band combinations.

28. The method of claim 27, wherein the set of network-specific features comprises one or more of the following with respect to the plurality of CA band combinations: a MIMO capability of the UE, a simultaneous RX/TX capability of the UE, support for dual-connectivity, and support for Channel State Information-Reference Signal (CSI-RS) procedure.

29. The method of claim 27, wherein the response comprises a bit string corresponding to the set of network-specific features for each CA band combination in the plurality of CA band combinations supported by the UE.

30. The method of claim 27, wherein the plurality of CA band combinations are supported by the wireless communication network and the set of network-specific features are supported by the wireless communication network on at least one of the plurality of CA band combinations.

31. The method of claim 27, wherein the set of network-specific features comprises a first bit string indicating the set of network-specific features supported for at least one of the plurality of CA band combinations and the response from the UE includes a second bit string indicating whether the UE supports the features in the set of network-specific features, wherein the first bit string and the second bit string have a same length.

32. The method of claim 31, wherein each bit of the first bit string corresponds to one feature of the set of network-specific features, and wherein each bit of the second bit string indicates whether the UE supports the corresponding feature.

33. The method of claim 27, wherein the response from the UE comprises a separate indication of support or a lack of support for each feature in the set of network-specific features for each of the plurality of CA band combinations supported by the UE.

34. The method of claim 27, further comprising:
determining resources for wireless communication with the UE based at least in part on the response.

35. An apparatus for wireless communication by a base station, comprising:
means for transmitting a request to a user equipment (UE) for UE capability information, wherein the request indicates at least one network supported UE capability; and
means for receiving a response from the UE for the indicated at least one supported UE capability.

36. The apparatus of claim 35, wherein the request specifies a plurality of carrier aggregation (CA) band combinations associated with a wireless communication network, and
wherein the response to the request comprises, for each specified CA band combination in the plurality of CA band combinations, an indication of whether the specified CA band combination is supported by the UE.

37. The apparatus of claim 36, wherein the response comprises a Boolean type response indicating whether the UE supports each of the plurality of CA band combinations.

38. The apparatus of claim 36, wherein the request comprises a set of network-specific features supported by the wireless communication network and corresponding to the plurality of CA band combinations, and
wherein the response to the request further comprises a separate indication of support or a lack of support for each feature in the set of network-specific features when operating in the plurality of CA band combinations.

39. An apparatus for wireless communication by a base station, comprising:
a memory; and
at least one processor coupled to the memory and configured to:
transmit a request to a user equipment (UE) for UE capability information, wherein the request indicates at least one network supported UE capability; and
receive a response from the UE for the indicated at least one supported UE capability.

40. The apparatus of claim 39, wherein the request specifies a plurality of carrier aggregation (CA) band combinations associated with a wireless communication network, and
wherein the response to the request comprises, for each specified CA band combination in the plurality of CA band combinations, an indication of whether the specified CA band combination is supported by the UE.

41. The apparatus of claim 40, wherein the response comprises a Boolean type response indicating whether the UE supports each of the plurality of CA band combinations.

42. The apparatus of claim 40, wherein the request comprises a set of network-specific features supported by the wireless communication network and corresponding to the plurality of CA band combinations, and
wherein the response to the request further comprises a separate indication of support or a lack of support for each feature in the set of network-specific features when operating in the plurality of CA band combinations.

43. A computer-readable medium storing computer executable code, comprising code to:
transmit a request to a user equipment (UE) for UE capability information, wherein the request indicates at least one network supported UE capability; and
receive a response from the UE for the indicated at least one supported UE capability.
